(19) United States
(12) Patent Application Publication
(10) Pub. No.: US 2026/0175227 A1
(43) Pub. Date: Jun. 25, 2026

(54) CELL STRETCHING DEVICE

(71) Applicants: HACETTEPE UNIVERSITESI, Ankara (TR); CANKAYA UNIVERSITESI, Ankara (TR)

(72) Inventors: Pervin Rukiye DINCER, Ankara (TR); Ismail UYANIK, Ankara (TR); Samet AKAR, Ankara (TR); Harun ARTUNER, Ankara (TR); Nilufer DUZ, Ankara (TR); Mustafa Ensar YAY, Ankara (TR); Selman SAHIN, Ankara (TR)

(73) Assignees: HACETTEPE UNIVERSITESI, Ankara (TR); CANKAYA UNIVERSITESI, Ankara (TR)

(21) Appl. No.: 19/124,909

(22) PCT Filed: Oct. 25, 2023
(86) PCT No.: PCT/TR2023/051194

§ 371 Date: Apr. 28, 2025

(30) Foreign Application Priority Data
Oct. 27, 2022 (TR) 2022/016331

(51) Int. Cl. B01L 3/00

(52) U.S. Cl. CPC B01L 3/5088; B01L 2200/0663

(57) ABSTRACT

Provided is a cell stretching device that creates stress by applying stretching to the cell to trigger mechanical signaling in the cell and thus biochemical signals. The cell stretching device includes the following: four stretching motors providing bidirectional linear movement and a control unit for controlling the frequency and movement distances of said stretching motors, at least one stretching plate connected to the linear movement outputs of the stretching motors for each edge of said membrane and a plurality of pin openings provided on the stretching plates for each membrane edge and enabling said membrane to be connected to the stretching plates.

### TECHNICAL FIELD

The invention relates to a cell stretching device that creates stress by applying stretching to the cell to trigger mechanical signaling in the cell and thus biochemical signals.

### STATE OF THE ART

Cell stretching devices have long been used to detect the behavior of cells under different stresses. In these devices, tensile force is applied by various drive elements to a membrane where cell culture is maintained and accordingly, the membrane stretches. With the stretching that occurs in the membrane, the behavior of the cells under mechanical loading is simulated.

A cell stretching system is described in the article titled “Device to Dynamically Stretch Cells during Microscopic Visualization”¹. One corner of a rectangular membrane is fixed and stretching is applied from the other three corners. Said fixing and stretching connections are provided by means of a pin.

The article titled “A dynamic stochastic model of frequency-dependent stress fiber alignment induced by cyclic stretch”² relates to a study to determine the specific response of cells to certain spatiotemporal changes in the matrix. A custom-made stretching device is used in the mentioned article. The stretching device can operate in different frequencies, sizes and patterns (uniaxial or biaxial). This system includes four linear motors facing towards a common center and is distributed evenly. No real-time monitoring is available in this study. A similar structure was described in the article titled “Differential effects of equiaxial and uniaxial strain on mesenchymal stem cells”³, and eight motors were used instead of four in this structure.

US 2012/219981 also describes a cell stretching device system that will create mechanical loading. Here, it is aimed to create a mechanical stretching based on the tensile force of the motors on the cell/tissue placed on the PDMS membrane. As an advantage of the disclosed device, it is described that it can apply voltage forces up to 10 Hz frequencies. However, in mechanobiology studies known in the literature, 2 Hz is not exceeded.

CN109468225A discloses a mechanical loading cell stretching device that can provide real-time data feedback.

In all these applications, the stretching force is applied to the membrane over the corners and accordingly, the homogeneous stress distribution is not reached on the membrane surface, and in addition, inward curves are formed on the edges and accordingly, the homogeneous usage area of the membrane is restricted.

All the problems mentioned above have made it necessary to make an innovation in the relevant field as a result.

### OBJECTS AND BRIEF DESCRIPTION OF THE INVENTION

The main object of the invention is to increase the homogeneity of stretching when applied to the membrane where cell culture is maintained.

The object of the invention is to provide the stretching force synchronously in the single-axis or multi-axis.

The object of the invention is to ensure that the stretching force can be applied in the two axes equally or independently of each other.

The object of the invention is to ensure that the stretching motors can follow the target voltage profile in real-time and instantaneously.

The present invention relates to a cell stretching device developed for stretching a cell sown membrane to meet the above mentioned requirements and objects. Accordingly, the present invention comprises four stretching motors providing bidirectional linear motion and a control unit for controlling the frequency and travel distances of said stretching motors, at least one stretching plate for each edge of said membrane, connected to the linear travel outputs of said stretching motors, and a plurality of pin openings provided on the stretching plates for each membrane edge, allowing the said membrane to be connected to the stretching plates.

Thus, traction on the membrane edges is distributed over multiple points. Accordingly, as a result of the stresses provided from the single point, the dispersed distribution of the stress on the membrane was prevented, and in addition, the problem of bending on the edges seen when the said membrane is stretched from a single point over the edge or corner was overcome and the area of use on the membrane was increased.

In one embodiment of the invention, pin openings are provided only in the edge plane in the stretching plate of a stretching device arranged especially for polygonal membranes, and pin openings are not included in the corners, and accordingly, the corner stretching is completely eliminated.

### DEFINITIONS OF FIGURES DESCRIBING THE INVENTION

The figures and related descriptions used to better explain the device developed by this invention are as follows.

FIG. 1. Schematic view of the stretching device of the invention

FIG. 2. Isometric image of an embodiment of the stretching device of the invention

### DEFINITIONS OF COMPONENTS/PIECES/PARTS OF THE INVENTION

In order to better explain the device developed by this invention, the parts and pieces in the figures are numbered and the corresponding numbers are given below.
1. Cell stretching device
   10. Stretching motor
      11. Motor housing
      12. Rail plate
      13. Retainer
   20. Stretching plate
      21. Pin openings
      22. Plate retainer
   B. Base
   R. Rail
   G. Guide
   S. Switch
   SR. Switch retainer
   H. Housing
   CU. Control unit
   UI. User Interface

### DETAILED DESCRIPTION OF THE INVENTION

The subject of the invention relates to a cell stretching device (1) that creates stress by applying stretching to the cell to trigger mechanical signaling in the cell and thus biochemical signals.

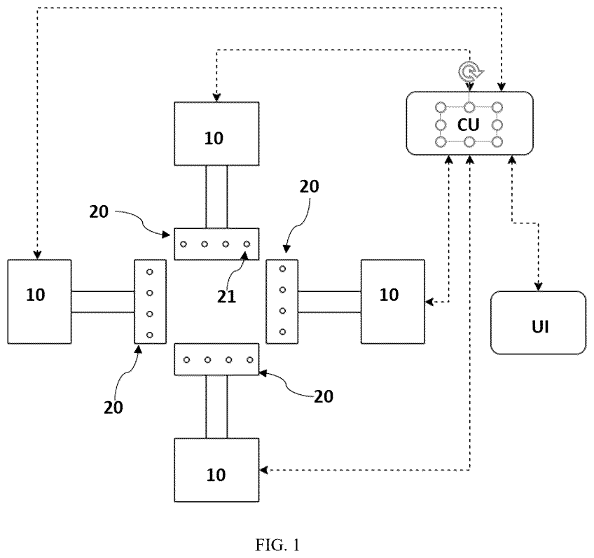

The stretching device (1) of the invention comprises four stretching motors (10), referring to FIG. 1. The stretching motors (10) are selected among the motors that provide linear motion. In the preferred embodiment, linear stepper motors are selected as stretching motors (10) due to their precision.

At the end of the stretching motors (10), there is a stretching plate (20) that can move in two directions on a linear axis with the drive it receives from the motor. The stretching plate (20) is basically used to attach the membrane to be used in the stretching process to the stretching motors (10).

The connection is carried out through the pins (P). There are multiple pin openings (21), preferably circular openings, on the stretching plate (20). In response to these pin openings (21), there are also openings in the membrane and the pin (P) passed through the openings fixes the membrane and the stretching plate (20) to each other.

Here, multiple pin openings (21) are arranged for each edge of the membrane. Accordingly, during the stretching that will occur when the stretching motor (10) pulls the stretching plates (20) in the opposite direction to the membrane, the multiple pin openings (21) ensure that the stretching on the entire membrane is more homogeneous by spreading the stretching force to more than one point on the edge of the membrane.

The stretching plate (20) provided for each edge may consist of a plurality of plates, and in this case, it will be sufficient to have a pin opening (21) in each plate forming the stretching plate (20) because, considering the totality of the plates, more than one pin opening (21) will still be provided for a membrane edge.

Here, in particular, the pin openings (21) are provided so that they do not coincide with the corner parts of the membrane. Accordingly, the stretching plate (20) can also be arranged so that it does not reach the corners of the membrane.

Preferably, the membrane-facing edge of the stretching plate (20) is in identical form to the edge of said membrane. For example, the edge of the stretching plate to be attached to the edge of a square membrane also has a flat edge facing that membrane.

Said stretching device (1) comprises a control unit (CU) to control the stretching motors (10) and thus the stretching process. The control unit (CU) and the stretching motors (10) perform two-way communication with each other. Here, both the commands from the control unit (CU) are transmitted to the stretching motor (10) and the stretching motor status information is transmitted from the stretching motor (10) to the control unit (CU). Here, data regarding the stretching motor (10) are transmitted to the said control unit (CU) in real-time.

Said control unit (CU) can individually control the stretching motors (10). In addition, said control unit (CU) can move the stretching motors (10) under certain groups on a synchronous or predetermined pattern.

Various operating modes are defined on the cell stretching device (1) to be carried out by the control unit (CU) in a preferred embodiment. The instructions for executing the operating modes may be stored by an integrated memory unit.

The mentioned operating modes are defined as sinusoidal and square stretching modes. In the first of these modes, the sinusoidal stretching movement, the stretching motors (10) continuously stretch and release the membrane without pausing. The second mode is square wave motion. This movement, unlike sinusoidal movement, moves the motor as quickly as possible, allowing the membrane to reach the maximum stretched state and to wait for a while in this stretched state and return it to its original position at the same speed.

The mentioned operating modes can be selected via a user interface (UI). The user interface (UI) may be executed through a device and may be configured to receive the user inputs necessary to execute the instructions necessary to activate said modes.

In addition, the instantaneous data of said stretching motors (10) can be shown in real-time through the user interface (UI).

Here, this data of the stretching motor (10) can be sent to the device where the user interface (UI) is executed through the control unit (CU), as well as directly to the device where the user interface (UI) is executed in the stretching motors (10). The data may be one of the frequency, amount of movement, speed of the stretching motor (10) or the membrane stretching characteristics derived from them.

From said user interface (UI), user instructions to be transmitted to the stretching motor (10) for determining the stretching period and stretching percentage can also be received.

The device on which the user interface (UI) is executed may be a mobile device or a computer. In addition, said device may include a touch screen for user inputs.

The control unit (CU) is also configured to control the periods of the stretching motors (10). Here, the membrane can be stretched in 6 different periods. These periods are 0.5, 1, 2, 3, 4, and 5 seconds, respectively. These values have been determined to cover the characteristics of the systems existing in the market. The cell stretching device (1), which is the subject of the invention, has the principle of including more options when necessary.

The control unit (CU) is configured to also control the membrane stretching face periods through the stretching motors (10). The manually controlled stress percentages are 5%, 10%, 15%, and 20%, respectively. These correspond to 2.5 mm, 5 mm, 7.5 mm and 10 mm for a 50 mm×50 mm membrane. Again, this feature was determined to cover the features of the options offered in the market.

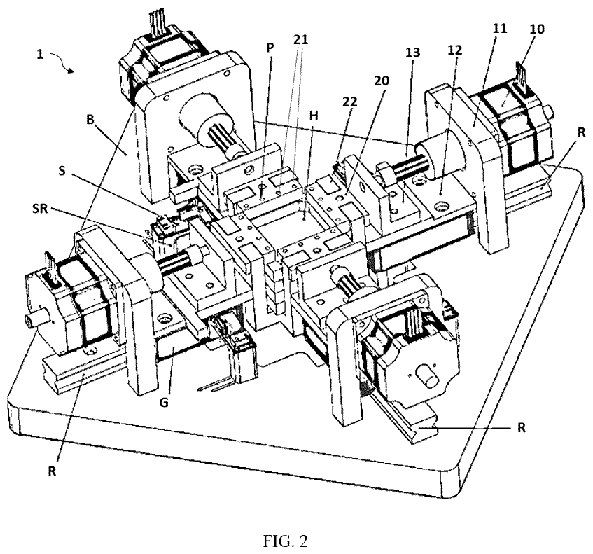

An embodiment of the stretching device of the invention is shown in FIG. 2. The cell stretching device (1) is installed on a base (B) plate. A rail (R) is arranged for each stretching motor (10) on the base (B) plate. Here, the rail (R) can be arranged according to the embodiments given above. The extension direction of the movement direction of the rails (R) and the stretching motors (10) is parallel, preferably conjugate, to each other.

A linear step motor is placed on the rails (R) as a stretching motor (10). A motor housing (11) for the stretching motors (10) is arranged on the base (B). A retainer (13) is disposed at the output end of the stepping motor, i.e. at the end of its shaft. The retainer (13) is connected to a guide (G) by means of a rail plate (12) and with the movement of the stretching motor (10), the retainer (13) slides on the rail (R) by means of the guide (G).

The retainer (13) basically transfers the movement it receives from the stretching motor (10) to the stretching plate (20) through the rail plate (12). The stretching plate (20) is attached by means of plate retainers (22).

The stretching plates (20) comprise four, variable, pin openings (21) on a longitudinal rod.

The desired stretching was tried to be created on the membrane by providing as precise control as possible with the stretching motors (10) of a real-time software infrastructure in the cell stretching device (1) subject to the invention. In this context, Helix Linear® Captive Linear Actuator-SMA-23S3.25V-C-037-400-1.00 model stepper motors and Leadshine® DM556 motor drives were used to drive these motors. These stepper motors can perform linear reciprocation, unlike normal stepper motors. Thanks to this linear movement, two-dimensional straightening of the membranes can be achieved by using four guides (G) connected to the motors. In addition, thanks to the high resolution offered by the DM556 motor driver, its motors can be controlled very precisely.

After installing the basic movement infrastructure with these two parts, the Texas Instruments® C2000 Delfino MCU F28379D model microcontroller, which is Matlab/Simulink® SLRT (real-time operating system) compatible, was selected to control the cell stretching device (1) as the control unit (CU) so that the motors can be controlled in real-time. Thanks to the high processing power of this microcontroller, software can be run at the desired frequencies.

In order to determine the frequency of the PWM signals to be applied to the stretching motors (10), the number of steps required for the 1 mm distance travel of the stretching motor (10) is primarily calculated. For the system to work with 6 different periods and 4 different stress percentages, there must be a total of 24 different frequency and step measurement combinations. The step size and PWM frequency of the stretching motors (10) must be different for each match for sensitive top-up. To perform this operation, the stretching motor (10) driver is operated in 1000 steps/revolution mode. Since the selected stretching motor (10) moves linearly, it progresses by 10 millimeters at a distance of 1 turn. As a result, the distance of 1 millimeter was determined as 100 steps. This clearly reveals how precise the movement provided in the invention can be.

This hardware feature of the stretching motors (10) has also been checked practically and the theoretically found values have been verified. In this way, a high motion sensitivity and a low error margin are obtained by controlling the motors over the number of steps. In addition, one edge length of the usable area of the membrane used in the studies is equal to 50 mm. In order to pull the membrane to the desired percentages, it must be stretched by 2.5 mm, 5 mm, 7.5 mm and 10 mm. In this context, the stretching motors (10) moved 250, 500, 750 and 1000 steps according to the flexion percentages. However, since the membranes are pulled from both sides, these distances correspond to the distances that the two motors must travel. The number of steps that the single stretching motor (10) should use is equal to half of this amount. That is, a motor travels 125, 250, 375 and 500 steps, respectively. In the following equation, the mathematical expression used to calculate the frequencies is specified.

$$Frequency = \frac{1}{Movement period} \times number of steps X 2$$

In this context, the frequencies of the PWM signals to be used by the stretching motors (10) according to different periods and movement percentages are summarized in the table below. All these values are integrated into the cell stretching device (1).

TABLE 1
Stretching distance and PWM frequency of a stretching
motor corresponding to the stretching period
and the percentage of stretching

| Stretching | Stretching | A single motor's | PWM frequency for |
|---|---|---|---|
| Period | Percentage | stretching distance | a single motor |
| (seconds) | (%) | (mm) | (Hz) |
| 0.5 | 5 | 0.625 | 500 |
| 0.5 | 10 | 1.25 | 1000 |
| 0.5 | 15 | 2.5 | 1500 |
| 0.5 | 20 | 5 | 2000 |
| 1 | 5 | 0.625 | 250 |
| 1 | 10 | 1.25 | 500 |
| 1 | 15 | 2.5 | 750 |
| 1 | 20 | 5 | 1000 |
| 2 | 5 | 0.625 | 125 |
| 2 | 10 | 1.25 | 250 |
| 2 | 15 | 2.5 | 375 |
| 2 | 20 | 5 | 500 |
| 3 | 5 | 0.625 | 83.33 |
| 3 | 10 | 1.25 | 166.67 |
| 3 | 15 | 2.5 | 250 |
| 3 | 20 | 5 | 333.33 |
| 4 | 5 | 0.625 | 62.5 |
| 4 | 10 | 1.25 | 125 |
| 4 | 15 | 2.5 | 187.5 |
| 4 | 20 | 5 | 250 |
| 5 | 5 | 0.625 | 50 |
| 5 | 10 | 1.25 | 100 |
| 5 | 15 | 2.5 | 150 |
| 5 | 20 | 5 | 200 |

### REFERENCES

1. Brent Duoba, Joseph Lombardo, Kyaw Thu Minn, Juan Rodriguez (2012) “Device to Dynamically Stretch Cells during Microscopic Visualization” A Major Qualifying Project Submitted to the Faculty of the WORCESTER POLYTECHNIC INSTITUTE
2. Hsu H-J, Lee C-F, Kaunas R (2009) “A Dynamic Stochastic Model of Frequency-Dependent Stress Fiber Alignment Induced by Cyclic Stretch”. PLoS ONE 4(3): e4853.
3. Jennifer S. Park, Julia S. F. Chu, Catherine Cheng, Fanqing Chen, David Chen, Song Li. Biotechnology and Bioengineering Volume 88, Issue3 Special Issue: Stem Cell Bioengineering, Pages 359-368 5 Nov. 2004

What is claimed is:

1. A cell stretching device for stretching a cell culture membrane, comprising the following:
four stretching motors providing a bidirectional linear movement, a control unit for controlling a frequency and movement distances of the four stretching motors, at least one stretching plate connected to linear movement outputs of the four stretching motors for each edge of the cell culture membrane, and a plurality of pin openings provided on the at least one stretching plates for each edge of the cell culture membrane and enabling the cell culture membrane to be connected to the at least one stretching plates.

2. The cell stretching device according to claim 1, wherein the four stretching motors move towards a common center and in an opposite direction.

3. The cell stretching device according to claim 2, wherein the at least one stretching plate is provided to form a quadrilateral.

4. The cell stretching device according to claim 1, wherein the plurality of pin openings provided for each edge of the cell culture membrane are distributed at equal distance intervals.

5. The cell stretching device according to claim 1, wherein the plurality of pin openings are provided in a way that the cell culture membrane is connected to the at least one stretching plate only from membrane edges.

6. The cell stretching device according to claim 1, wherein the control unit is configured to control the four stretching motors independently of each other.

7. The cell stretching device according to claim 1, wherein the control unit is configured to control at least two of the four stretching motors to move synchronously with each other.

8. The cell stretching device according to claim 7, wherein the control unit is configured to control a synchronous movement of at least two of the four stretching motors moving on a common axis with each other.

9. The cell stretching device according to claim 6, further comprising a device, wherein a user interface is executed in the device with options to enable responses of at least one of the four stretching motors to operate within predetermined instructions to be generated by the control unit.

10. The cell stretching device according to claim 6, further comprising a device, wherein a user interface is executed in the device with options to enable responses to be generated by the control unit, so that the four stretching motors operate synchronously with respect to each other within predetermined instructions.

11. The cell stretching device according to claim 1, wherein the control unit and the four stretching motors are configured to detect at least one of the frequency of the four stretching motors, an amount of movement, a speed, or membrane stretch characteristics in real-time, wherein the membrane stretch characteristics are derived from the frequency of the four stretching motors, the amount of movement, and the speed.

12. The cell stretching device according to claim 11, further comprising a device, wherein data detected depending on characteristics of the four stretching motors are transmitted to the control unit in the device.

13. The cell stretching device according to claim 2, wherein the plurality of pin openings provided for each edge of the cell culture membrane are distributed at equal distance intervals.

14. The cell stretching device according to claim 3, wherein the plurality of pin openings provided for each edge of the cell culture membrane are distributed at equal distance intervals.

15. The cell stretching device according to claim 2, wherein the plurality of pin openings are provided in a way that the cell culture membrane is connected to the at least one stretching plate only from membrane edges.

16. The cell stretching device according to claim 3, wherein the plurality of pin openings are provided in a way that the cell culture membrane is connected to the at least one stretching plate only from membrane edges.

17. The cell stretching device according to claim 4, wherein the plurality of pin openings are provided in a way that the cell culture membrane is connected to the at least one stretching plate only from membrane edges.

18. The cell stretching device according to claim 7, further comprising a device, wherein a user interface is executed in the device with options to enable responses of at least one of the four stretching motors to operate within predetermined instructions to be generated by the control unit.

19. The cell stretching device according to claim 8, further comprising a device, wherein a user interface is executed in the device with options to enable responses of at least one of the four stretching motors to operate within predetermined instructions to be generated by the control unit.

20. The cell stretching device according to claim 7, further comprising a device, wherein a user interface is executed in the device with options to enable responses to be generated by the control unit, so that the four stretching motors operate synchronously with respect to each other within predetermined instructions.
